(19) United States
(12) Patent Application Publication
(10) Pub. No.: US 2011/0052293 A1
(43) Pub. Date: Mar. 3, 2011

(54) POST IMAGE TRANSFER FINISHING IN LIQUID ELECTRO-PHOTOGRAPHIC PRINTING

(75) Inventors: David S. Vejtasa, Poway, CA (US); Clayton L. Holstun, San Marcos, CA (US); Forest Sun Patton, San Diego, CA (US)

(73) Assignee: Hewlett-Packard Development Company LP

(21) Appl. No.: 12/910,765

(22) Filed: Oct. 22, 2010

Related U.S. Application Data
(63) Continuation of application No. PCT/US2008/061115, filed on Apr. 22, 2008.

(51) Int. Cl. G03G 15/00

(52) U.S. Cl. 399/407

(57) ABSTRACT

In one embodiment, an LEP print engine includes a post image transfer finishing unit configured to alter a surface texture of the toner image on a print medium to a more uniform surface texture. In one embodiment, an LEP print engine includes a post image transfer finishing unit configured to simultaneously apply heat and pressure to the toner image on the print medium.

The present application is a continuation of co-pending PCT/US2008/061115 filed on Apr. 22, 2008 by David S. Vejtasa, Clayton L. Holstun and Forest Sun Patton and entitled POST IMAGE TRANSFER FINISHING IN LIQUID ELECTRO-PHOTOGRAPHIC PRINTING, the full disclosure of which is hereby incorporated by reference

### BACKGROUND

Liquid electro-photographic (LEP) printing, sometimes also referred to as liquid electrostatic printing, uses liquid toner to form images on paper or other print medium. LEP is often used for large scale commercial printing. The basic LEP printing process involves placing a uniform electrostatic charge on a photoconductor, the photoconductive surface on a rotating drum for example, and exposing the photoconductor to light in the pattern of the desired printed image to dissipate the charge on the areas of the photoconductor exposed to the light. The resulting latent electrostatic image on the photoconductor is developed by applying a thin layer of liquid toner to the photoconductor. Liquid toner generally consists of charged toner particles dispersed in a carrier liquid. The charged toner particles adhere to the discharged areas on the photoconductor (discharged area development DAD) or to the charged areas (charged area development CAD), depending on the charge of the toner particles, to form the desired toner image on the photoconductor. The toner image is transferred from the photoconductor to an intermediate transfer member and then from the intermediate transfer member to the paper or other print medium.

In some LEP printers, the intermediate transfer member includes a removable, replaceable “blanket” wrapped around a rotating drum. The toner image on the surface of the photoconductive drum is transferred to the surface of the blanket as the surface of the blanket rotates against the surface of the photoconductive drum. The toner image on the blanket is then transferred to the paper as the paper is pressed against the blanket while passing through a nip between the intermediate transfer member/drum and a pressure roller. When the same image is printed repeatedly, many times in succession before printing a new image, as is often the case in commercial printing when hundreds or thousands of pages may be printed with the same image, the blanket may retain or “remember” the old image when a new image is printed due to differential wear of the outer, release layer on the intermediate transfer member blanket. If the blanket's memory of the old image is sufficiently strong, the old image may be visible in the new image. This undesirable phenomenon, which is referred to as gloss memory, may become more pronounced as the blanket ages until, eventually, the blanket must be replaced due to a gloss memory “failure.”

### DRAWINGS

FIG. 1 is a block diagram illustrating the basic components an LEP print engine according to an embodiment of the disclosure.

FIG. 2 is a perspective view illustrating an LEP printer constructed according to one embodiment of the disclosure.

FIG. 3 is perspective view illustrating in more detail the print engine in the printer shown in FIG. 3.

FIG. 4 is a flow chart illustrating an LEP printing method according to an embodiment of the disclosure.

### DESCRIPTION

Embodiments of the disclosure were developed in an effort to extend the useful life of the blanket on an intermediate transfer member in an LEP printer by reducing the effects of gloss memory. It has been discovered that altering the surface texture of the printed toner image to a more uniform texture can extend the life of the intermediate transfer member blanket by masking the onset of a gloss memory failure. One technique for altering the surface texture of the printed image is to simultaneously apply heat and pressure to the printed image. It has been observed that such post image transfer finishing operations also may be used to improve adhesion between the toner layer/image and the print media and to selectively improve or change gloss levels.

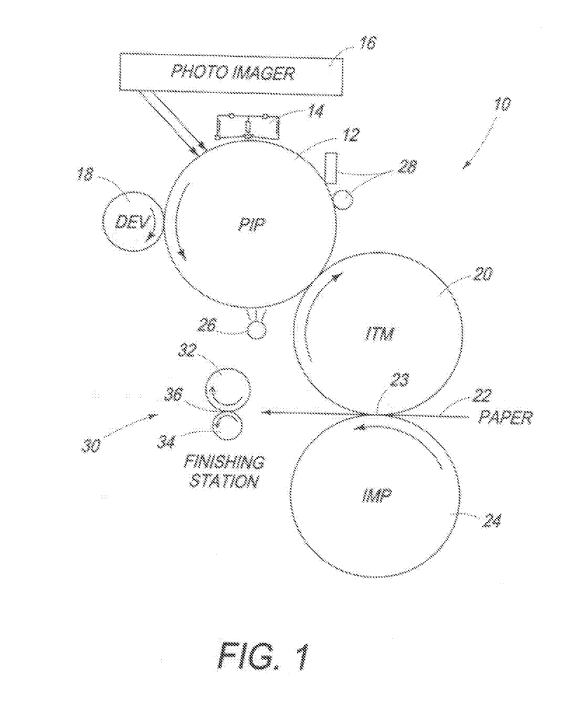

FIG. 1 is a block diagram illustrating the basic components of an LEP print engine 10 according to one embodiment of the disclosure. Referring to FIG. 1, in print engine 10 a uniform electrostatic charge is applied to a photoconductive surface, the outer surface of a photoconductor drum 12 for example, by a scorotron or other suitable charging device 14. The photoconductor 12 used for LEP printing is commonly referred to as a photo imaging plate (PIP). A scanning laser or other suitable photo imaging device 16 exposes selected areas on photoconductor 12 to light in the pattern of the desired printed image to dissipate the charge on the areas of photoconductor 12 exposed to the light. In discharge area development (DAD), for example, the discharged areas on photoconductor 12 form an electrostatic image which corresponds to the image to be printed. This electrostatic image is said to be a “latent” image because it has not yet been developed into a toner image. A thin layer of liquid toner is applied to the patterned photoconductor 12 using a developer roller 18. Developer roller 18 represents generally a typically complex developer unit, often referred to as a binary ink developer (BID), that supplies ink to a small roller that rotates against photoconductor 12. Hence, the developer unit is depicted generally in FIG. 1 by a developer roller 18.

The latent image on photoconductor 12 is developed through the application of the liquid toner which adheres to the discharged areas of photoconductor 12 in a uniform layer of toner on photoconductor 12, developing the latent electrostatic image into a toner image. The toner image is transferred from photoconductor 12 to an intermediate transfer drum/member (ITM) 20 and then from intermediate transfer member 20 to paper or other print medium 22 as paper 22 passes through a nip 23 between intermediate transfer member 20 and a pressure roller 24. Print medium 22, which is also referred to as paper 22, represents generally any suitable print medium and may be delivered to print engine 10 as a continuous web dispensed from a roll or as individual sheets. Pressure roller 24 is commonly referred to as an impression cylinder (IMP). An LED lamp or other suitable discharging device 26 removes residual charge from photoconductor 12 and toner residue is removed at a cleaning station 28 in preparation for developing the next image or for applying the next toner color plane. Components 12-28 of print engine 10 are conventional components whose structure and operation is well known to those skilled in the art of LEP printing.

Intermediate transfer member 20 typically will include a removable, replaceable blanket wrapped around a drum. The comparatively soft, compliant blanket is heated to drive off most of the carrier fluid component of the liquid toner and, in one example process using Hewlett-Packard Co. ElectroInk® liquid toner, the toner dries to an approximately 90% solid layer about 1 μm thick before being transferred to paper 22. The thin layer of toner is then transferred, and simultaneously fused, to paper 22 through the application of pressure at the nip 23 between transfer member 20 and impression cylinder 24. Unlike electro-photographic printers that use dry toner, in which the dry toner particles are transferred to the paper and then fused at a downstream fuser in a separate operation, the liquid toner used in LEP printers is transferred and fused to the paper at the same time in a single operation. Thus, a subsequent fusing operation has not heretofore been deemed necessary or desirable, and is not used, in conventional LEP printers.

After the toner layer/image has been transferred and fused to paper 22 at nip 23, paper 22 passes through a finishing station 30. In the embodiment shown, finishing station 30 includes a heated finishing roller 32 and a mating pressure roller 34. Heat and pressure are applied to the toner layer on paper 22 as paper 22 passes through a nip 36 between rollers 32 and 34. Finishing station 30 might also be characterized as a re-finishing station in the sense that, in a conventional LEP print engine, the image is “finished” after it is transferred from the intermediate transfer member to the paper. Thus, the image may be said to be “re-finished” in the new LEP print engine 10 through the application of heat and pressure at nip 36. Selectively applying heat and pressure at finishing station 30 re-fixes memories of an old image that may be present in the toner layer on paper 22 so that the old image is not visible in the new image, as described in more detail below. This refinishing operation may also be used to adjust the gloss level of the toner layer and develop better adhesion of the toner layer to paper 22.

In an LEP print engine, when the same image is repeatedly applied to and then transferred from the intermediate transfer member many times in succession, the surface texture of that area of the blanket to which the image is applied may change, becoming different from the surface texture on other areas of the blanket. Thus, the blanket retains or “remembers” this image as variations in the surface texture of the blanket. Since the surface of the toner image in LEP is in direct contact with the surface of the intermediate transfer member blanket, differential surface textures on the blanket left from printing the old image may appear on the surface of the new toner image. This phenomenon is called gloss memory. When the new toner image is transferred to the paper, light will reflect differently off areas with different surface textures and, hence, the old image may be visible in the new image. LEP toners are so thin, however, that the toner image reflects the underlying surface roughness of the paper and the gloss level of the toner image is determined by the paper as well as the surface texture of the toner image. Nevertheless, the application of heat and pressure to the toner image after it has been transferred to the paper will still reduce or eliminate the differences in surface texture manifesting as gloss memory by altering the surface texture of the toner image, giving the top surface of the toner image on the paper a more uniform texture that reflects light more consistently.

In one example configuration for finishing station 30, suitable for re-finishing an ElectroInk® toner layer approximately 1 μm thick on paper 22, finishing roller 32 is heated to an exterior surface temperature in the range of 160° C. to 190° C. while exerting a pressure on paper 22 at nip 36 in the range of 60 kPa to 90 kPa at a paper feed rate of approximately 1 m per second. It is expected that these operating parameters for finishing station 30 will be sufficient to suppress the effects of gloss memory that might otherwise be visible in the new image. Other configurations are possible. It may be desirable to vary the temperature, pressure and/or feed rate at finishing station 30 to achieve different degrees of gloss memory suppression and/or to help produce a desired gloss on the printed image.

Also, the surface texture of finishing roller 32 may be specifically designed to help produce a desired gloss on the printed image—matte, medium, or a high gloss photo finish, for example.

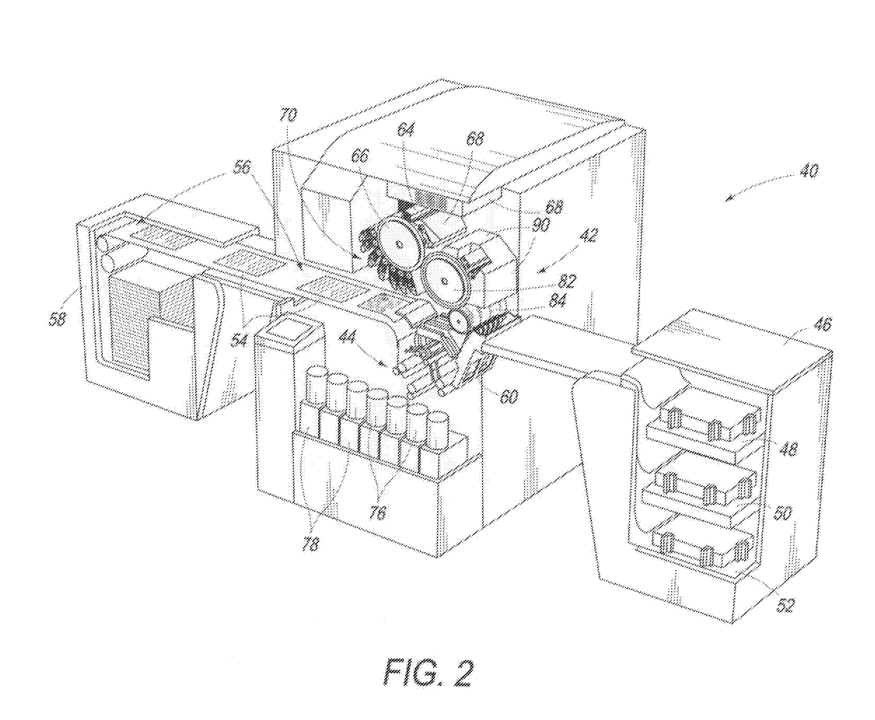

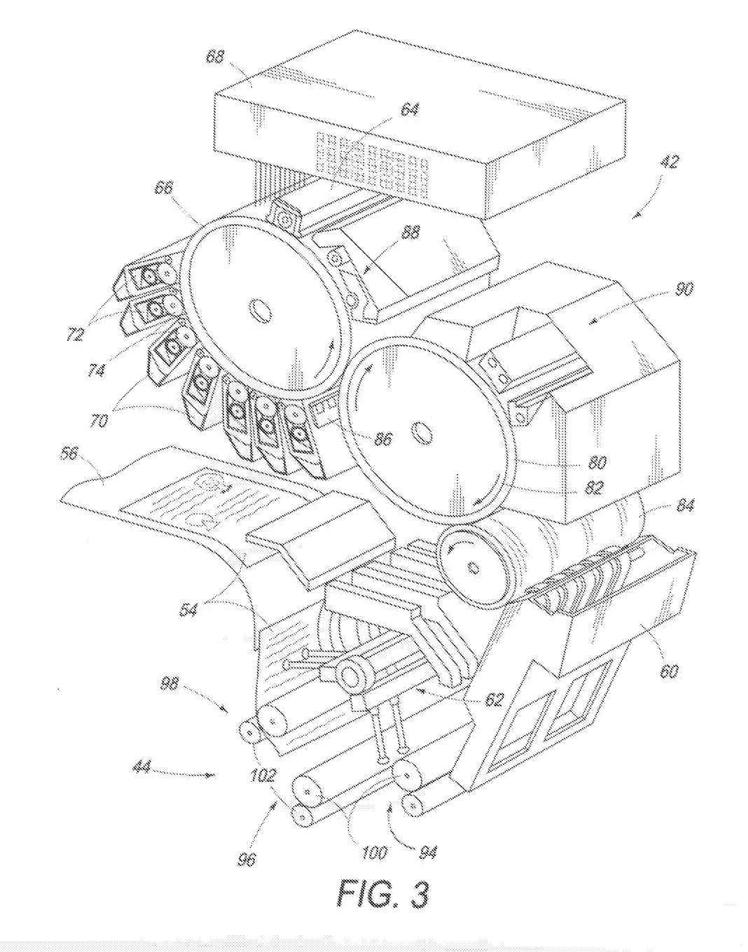

FIG. 2 illustrates one embodiment of an LEP printer 40 implementing a print engine 42 with a post image transfer finishing station 44. FIG. 3 is a detail view of print engine 42. Printer 40 generally reflects the configuration of an HP Indigo® Press 5500 LEP printing press adapted to implement one embodiment of a print engine that includes a post image transfer finishing station. Referring to FIGS. 2 and 3, printer 40 includes a paper feed unit 46 with multiple paper input trays 48, 50, and 52. Sheets of paper are fed from stacks 48-50 across a feed bridge 54 to print engine 42 from which they emerge as printed sheets 54 conveyed along a discharge paper path 56 to an output stacker 58. Although not shown, various operations may be performed along discharge path 56 including, for example, ILD (in-line densitometer) color calibration and adjustment and sheet routing to a proof tray. Printed sheets 54 may be routed back through print engine 42 via a duplex conveyor 60 at the urging of a so-called exit guide perfector 62 configured to selectively move sheets 54 out to discharge path 56 or back through duplex conveyor 60.

Print engine 42 includes a scorotron charging device 64 located adjacent to a photoconductor 66 for applying a uniform electric charge to photoconductor 66. A photo imaging device 68 exposes selected areas on photoconductor 66 to light in the pattern of the desired printed image. A thin layer of liquid toner is applied to the patterned photoconductor 66 through one or more of a series of developer units 70 to develop the latent image on photoconductor 66 into a toner image. Each developer unit 70 moves ink from an internal reservoir 72 to a developer roller 74 that rotates against photoconductor 66. Each developer unit 70 usually applies a different color ink from a corresponding series of toner supply cans 76. The toner held in each supply can 76 is typically about 20% solids, having the consistency of toothpaste. The paste-like toner is diluted to about 2% solids in dilution tanks 78 before it is pumped to a developer unit 70 and applied to photoconductor 66.

The toner image is transferred from photoconductor 66 to the outside surface a replaceable blanket 80 on an intermediate transfer member 82. The toner image is then transferred and fused to the paper as the paper passes through the nip between intermediate transfer member 82 and a pressure roller 84. An LED lamp or other suitable discharging device 86 removes residual charge from photoconductor 66. Toner residue is removed at a cleaning station 88 in preparation for developing the next image or applying the next toner color plane. Volatile fumes generated as the toner carrier fluid evaporates off intermediate transfer member blanket 80 are evacuated through a suction hood 90.

After the toner layer/image has been transferred and fused to the paper, the paper passes through finishing station 44. In the embodiment shown, finishing station 44 includes three finishing units 94, 96, and 98. Each finishing unit 94-98 includes a heated finishing roller 100 and a mating pressure roller 102 that are selectively engaged individually (one at a time) to re-finish a printed sheet 54 according to a desired gloss level. The surface texture of each finishing roller 110 in each unit 94-98 and the operating temperatures and pressures for each unit 94-98 may be configured to achieve the desired gloss level, for example a matte gloss for finishing unit 94, a medium gloss for finishing unit 96, and a high gloss, photo finish for finishing unit 98.

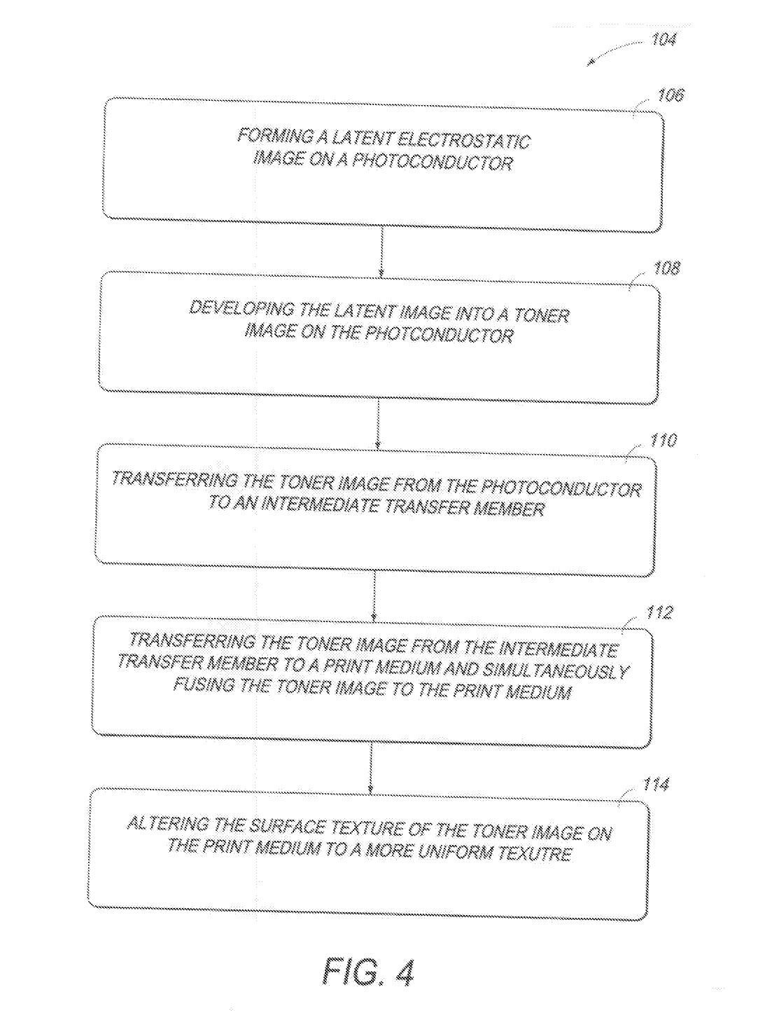

Referring now to FIG. 4, a flowchart illustrating a method 104, in an exemplary embodiment of the disclosure, for reducing the effects of gloss memory in LEP printing. Referring to FIG. 4, a latent electrostatic image is formed on a photoconductor (step 106). The latent image may be formed, as described above, by charging the photoconductor to a uniform level and then exposing the charged photoconductor to light in a pattern of a desired printed image to discharge the exposed areas of the photoconductor. The latent image is developed into a toner image (step 108) by applying a thin layer of liquid toner to the photoconductor. Charged toner particles adhere to the discharged areas, for example, of the photoconductor to form the desired toner image. The toner image on the photoconductor is transferred from the photoconductor to an intermediate transfer member (step 110) and then from the intermediate transfer member to a paper or other sheet or roll/web print medium and simultaneously fused to the paper (step 112). Then, the surface texture of the toner image on the print medium is altered to a more uniform texture (step 114) by, for example, simultaneously applying heat and pressure to the printed image.

The example embodiments shown in the figures and described above illustrate but do not limit the disclosure. Other forms, details, and embodiments may be made and implemented. Therefore, the foregoing description should not be construed to limit the scope of the disclosure, which is defined in the following claims.

What is claimed is:

1. An LEP print engine, comprising:
a photoconductor;
an imager configured to selectively expose areas of the photoconductor to a light in a predetermined pattern;
an image developer for applying a layer of liquid toner to the photoconductor;
an intermediate transfer member for receiving a toner image from the photoconductor and thereafter releasing the toner image to a print medium; and
a finishing unit configured to receive a print medium having a toner image thereon and alter a surface texture of the toner image to a more uniform surface texture.

2. The print engine of claim 1, wherein the finishing unit configured to alter a surface texture of the toner image to a more uniform surface texture comprises a finishing unit configured to simultaneously apply heat and pressure to the toner image on the print medium.

3. The print engine of claim 2, wherein the finishing unit comprises a first roller and a second roller pressable together at a nip, the first roller and/or the second roller being heatable such that a print medium passing through the nip may be simultaneously subjected to heat and pressure.

4. The print engine of claim 1, wherein the finishing unit comprises a first roller and a second roller pressable together at a nip, the first roller having a surface texture thereon for altering the surface texture of the toner image as it passes through the nip.

5. The print engine of claim 1, wherein the intermediate transfer member includes a replaceable blanket having an outer surface susceptible to gloss memory.

6. The print engine of claim 1, further comprising a pressure roller pressable against the intermediate transfer member at a nip such that a print medium passing through the nip is subjected to pressure that helps fuse the toner image to the print medium as it is released from the intermediate transfer member.

7. An LEP print engine, comprising:
a rotatable photoconductor;
a charging device operatively coupled to the photoconductor, the charging device configured to apply a uniform electrostatic charge to an outer surface of the photoconductor;
a photo imager operatively coupled to the photoconductor, the photo imager configured to selectively discharge areas of the outer surface of the photoconductor;
a plurality of developer rollers operatively coupled to the photoconductor, each developer roller configured to apply a layer of liquid toner to the outer surface of the photoconductor;
an intermediate transfer member operatively coupled to the photoconductor, the intermediate transfer member having an outer surface susceptible to gloss memory and the intermediate transfer member configured to receive a toner image from the outer surface of the photoconductor on to the outer surface of the intermediate transfer member and thereafter release the toner image to a print medium;
a rotatable member cooperating with the intermediate transfer member to simultaneously transfer the toner image from the outer surface of the intermediate transfer member to the print medium and fuse the toner image to the print medium; and
a finishing unit positioned downstream from the intermediate transfer member along a print medium path through the print engine, the finishing unit configured to simultaneously apply heat and pressure to the toner image on the print medium.

8. The print engine of claim 7, wherein the finishing unit is configured to apply a predetermined surface texture to a surface of the toner image on the print medium.

9. The print engine of claim 8, wherein the finishing unit comprises a plurality of finishing units each configured to simultaneously apply heat and pressure to the toner image on the print medium and to apply a predetermined surface texture, different from a surface texture applied by each of the other finishing units, to the surface of the toner image on the print medium.

10. The print engine of claim 7, wherein the finishing unit comprises a first roller and a second roller pressable together at a nip, the first roller and/or the second roller being heatable such that a print medium passing through the nip may be simultaneously subjected to heat and pressure.

11. An LEP printing method, comprising:
forming a latent electrostatic image on a photoconductor;
using liquid toner, developing the latent image into a toner image on the photoconductor;
transferring the toner image from the photoconductor to an intermediate transfer member;
transferring the toner image from the intermediate transfer member to a print medium and simultaneously fusing the toner image to the print medium; and
altering a surface texture of the toner image on the print medium to a more uniform texture.

12. The method of claim 11, wherein altering a surface texture of the toner image on the print medium to a more uniform texture comprises simultaneously applying heat and pressure to the toner image on the print medium.

13. The method of claim 11, wherein altering a surface texture of the toner image on the print medium to a more uniform texture comprises applying a predetermined surface texture to the toner image.

14. The method of claim 13, wherein the predetermined surface texture comprises a matte finish, a medium finish, or a high gloss photo finish.

15. An LEP print engine, comprising:
a means for forming a latent electrostatic image on a photoconductor;
a means for, using liquid toner, developing the latent image into a toner image on the photoconductor;
a means for transferring the toner image from the photoconductor to an intermediate transfer member;
a means for transferring the toner image from the intermediate transfer member to a print medium and simultaneously fusing the toner image to the print medium; and
a means for altering a surface texture of the toner image on the print medium to a more uniform texture.

16. The print engine of claim 15, wherein the means for altering a surface texture of the toner image on the print medium to a more uniform texture comprises a means for simultaneously applying heat and pressure to the toner image on the print medium.

17. The print engine of claim 16, wherein the means for simultaneously applying heat and pressure to the toner image on the print medium comprises a first roller and a second roller pressable together at a nip, the first roller and/or the second roller being heatable such that a print medium passing through the nip may be simultaneously subjected to heat and pressure.
